(19) United States
(12) Patent Application Publication
(10) Pub. No.: US 2025/0317360 A1
(43) Pub. Date: Oct. 9, 2025

(54) METHOD AND APPARATUS FOR MANAGING NETWORK FUNCTION IN COMMUNICATION SYSTEM

(71) Applicant: SAMSUNG ELECTRONICS CO., LTD., Suwon-si (KR)

(72) Inventors: Dongeun SUH, Suwon-si (KR); Jungshin PARK, Suwon-si (KR); Hoyeon LEE, Suwon-si (KR)

(21) Appl. No.: 19/094,318

(22) Filed: Mar. 28, 2025

(30) Foreign Application Priority Data
Apr. 4, 2024 (KR) 10-2024-0045782

(51) Int. Cl. H04L 41/14

(52) U.S. Cl. CPC H04L 41/14

(57) ABSTRACT

The disclosure relates to a 5G or 6G communication system for supporting a higher data transmission rate. Provided is a method performed by a network data analytic function (NWDAF) entity in a communication system. The method may include receiving, from a consumer network function (NF) entity, an analytic information request message or subscription message including threshold information; in response to the reception of the analytic information request message or the subscription message, collecting first analytic information from an orchestration and management (OAM) entity, a network repository function (NRF) entity, or at least one NF entity; deriving second analytic information based on the first analytic information; and transmitting, to the consumer NF entity, the second analytic information related to the at least one NF that operates abnormally.

### CROSS-REFERENCE TO RELATED APPLICATION

This application is based on and claims priority under 35 U.S.C. § 119 to Korean Patent Application No. 10-2024-0045782, filed on Apr. 4, 2024, in the Korean Intellectual Property Office, the disclosure of which is herein incorporated by reference in its entirety.

### BACKGROUND

### 1. Field

The disclosure relates to a method and apparatus for managing a network function in a communication system and, particularly, relates to a method and apparatus for managing a network function based on network function (NF) analytic information in a communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure is to provide a method and apparatus for managing a network function in a communication system.

Another aspect of the disclosure is to provide a method and apparatus for managing a network function based on network function (NF) analytic information in a communication system.

According to an aspect of the disclosure, a method performed by a network data analytic function (NWDAF) entity in a communication system is provided, and the method may include an operation receiving, from a consumer network function (NF) entity, an analytic information request message that requests analytic information associated with NF instances, an operation of collecting analytic information associated with the NF instances from an orchestration and management (OAM) entity, a network repository function (NRF) entity, or at least one NF entity, in response to the reception of the analytic information request message, an operation of detecting at least one NF instance that operates abnormally from among the NF instance, based on the analytic information associated with the NF instances, collected from the OAM entity, NRF entity, or at least one NF entity, and an operation of transmitting, to the consumer NF entity, information related to the at least one NF instance that operates abnormally.

According to another aspect of the disclosure, a network data analytic function (NWDAF) entity in a communication system is provided and the NWDAF entity includes a transceiver and at least one processor, and the at least one processor is configured to receive, from a consumer network function (NF) entity via the transceiver, an analytic information request message that requests analytic information associated with NF instances, to collect, via the transceiver, analytic information associated with the NF instances from an orchestration and management (OAM) entity, a network repository function (NRF) entity, or at least one NF entity, in response to the reception of the analytic information request message, to detect at least one NF instance that operates abnormally from among the NF instances, based on the analytic information associated with the NF instances, collected from the OAM entity, the NRF entity, or the at least one NF entity, and to transmit, to the consumer NF entity via the transceiver, information related to the at least one NF instance that operates abnormally.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates a network structure and an interface of a 5G system according to an embodiment of the disclosure;

FIG. 2 illustrates a signal flowgraph illustrating a procedure that provides analytic information related to abnormal event detection and prediction according to an embodiment of the disclosure;

FIG. 3 illustrates a signal flowgraph illustrating an NF status update or NF priority update procedure based on NF analytic information according to an embodiment of the disclosure;

FIG. 4 illustrates an example of the structure of a network entity according to an embodiment of the disclosure;

FIG. 5 illustrates an example of the structure of a UE according to an embodiment of the disclosure;

FIG. 6 illustrates an example of a structure of a UE according to an embodiment of the disclosure; and

FIG. 7 illustrates an example of a structure of a network entity according to an embodiment of the disclosure.

### DETAILED DESCRIPTION

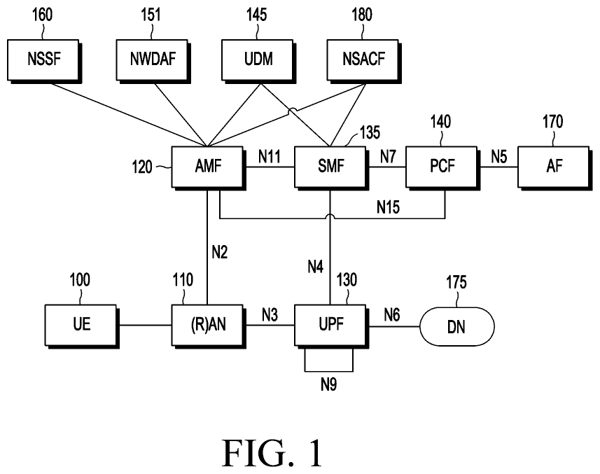

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, exemplary embodiments of the disclosure will be described in detail with reference to the accompanying drawings. It should be noted that, in the accompanying drawings, the same or like elements are designated by the same or like reference signs as much as possible. Also, a detailed description of known functions or configurations that may make the subject matter of the disclosure unnecessarily unclear will be omitted.

In describing the embodiments in the specification, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card.

In the embodiments of the disclosure, a base station is an entity that allocates resources to a terminal, and may be at least one of a gNode B, a gNB, an eNode B, an eNB, a Node B, a base station (BS), a wireless access unit, a base station controller, and a node on a network. Furthermore, the base station may be a network entity including at least one of an integrated access and backhaul-donor (IAB-donor) which is a gNB providing network access to a terminal (or terminals) via a network of backhaul and access links, and an IAB-node which is an RAN node supporting an NR access link(s) to a terminal (or terminals) and supporting NR backhaul links to the IAB-donor or any other IAB-node. A terminal may perform radio access via an IAB-node and transmit/receive data to/from an IAB-donor connected to at least one IAB-node via a backhaul link.

In addition, the terminal may include a user equipment (UE), a mobile station (MS), a cellular phone, a smartphone, a computer, or various devices capable of performing communication functions. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

In the following description, terms for identifying access nodes, terms referring to network entities, terms referring to messages, terms referring to interfaces between network entities, terms referring to various identification information, and the like are illustratively used for the sake of descriptive convenience. In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may be used.

Furthermore, various embodiments of the disclosure will be described using terms used in some communication standards (e.g., the 3rd generation partnership project (3GPP)), but they are for illustrative purposes only. Various embodiments of the disclosure may be easily applied to other communication systems through modifications.

FIG. 1 illustrates a network structure and an interface of a 5^{th} generation (5G) system according to an embodiment of the disclosure.

The 5G mobile communication network is configured with a 5G user equipment (UE) (terminal), a 5G radio access network (RAN), a base station, a 5g nodeB (gNB), an evolved nodeB (eNB or the like), and a 5G core network. The 5G core network is configured with network functions (NFs) such as an access and mobility management function (AMF) that provides a mobility management function of a UE, a session management function (SMF) that provides a session management function, a user plane function (UPF) that transfers data, a policy control function (PCF) that provides a policy control function, a unified data management (UDM) that provides a function of managing data such as subscriber data, policy control data, and the like, a unified data repository (UDR) that stores data of various network functions (NFs) such as a UDM or the like. The 5G core network may be configured by further including a plurality of NFs, such as a network slice selection function (NSSF), a network data analytic function (NWDAF), an application function (AF), a data network (DN), a network slice admission control function (NSACF), and the like.

Each NF entity of the 5G system may support the following functions.

For example, the 5G system may include an authentication server function (AUSF) entity, an access and mobility management function (AMF) entity 120, a session management function (SMF) entity 135, a policy control function (PCF) entity 140, an application function (AF) entity 170, a unified data management (UDM) entity 145, a data network (DN) 175, a network slicing selection function (NSSF) entity 160, a user plane function (UPF) entity 130, a radio access network (RAN) 110, an NWDAF 151, an NSACF 180, and a terminal, for example, a user equipment (UE) 100.

The authentication server function (AUSF) entity may process and store data for authenticating the UE 100.

The access and mobility management function ((core) access and mobility management function (AMF)) entity 120 may provide a function for access and mobility management in units of UEs, and basically, a single AMF is connected for each UE. Specifically, the AMF entity 120 may support functions, such as inter-CN node signaling for mobility between 3GPP access networks, termination of an radio access network (RAN) CP interface (i.e., N2 interface), termination (N1) of non-access stratum (NAS) signaling, NAS signaling security (NAS ciphering and integrity protection), AS security control, registration management (e.g., registration area management), connection management, idle mode UE reachability (including control and performing of paging retransmission), mobility management control (subscription and policy), support of intra-system mobility and inter-system mobility, support of network slicing, selection of a session management function (SMF), lawful intercept (with respect to an AMF event and an interface to an L1 system), transferring of a session management (SM) message between a UE and an SMF, transparent proxy for SM message routing, access authentication, access authorization including roaming authority checking, providing transferring of an SMS message between a UE and an SMSF, a security anchor function (SAF), and/or security context management (SCM) or the like. Some or all of the functions of the AMF entity 120 may be supported in a single instance of a single AMF entity.

The data network (DN) 175 may be, for example, an operator service, an internet access, or a 3rd party service, or the like. The DN 175 may transmit a downlink protocol data unit (PDU) to the user plane function (UPF) entity 130, or may receive, from the UPF entity 130, a PDU transmitted from the UE 100.

The policy control function (PCF) entity 140 may receive information associated with a packet flow from an application server, and may provide a function of determining a policy associated with mobility management, session management, and the like. Specifically, the PCF entity 140 may support functions such as supporting a unified policy framework to control network operations, providing policy rules so that a control plane function entity (entities) (e.g., AMF entity, SMF entity, and the like) implements the policy rules, implementing a front end for accessing related subscription information for determining a policy in a user data repository (UDR).

The session management function (SMF) entity 135 may provide a session management function, and, when the UE 100 has a plurality of sessions, the sessions may be managed by respectively different SMF entities. Specifically, the SMF entity 135 may support functions such as session management (e.g., establishing, correcting, and releasing a session including maintaining a tunnel between the UPF entity 130 and a radio access node (RAN) 110), UE IP address allocation and management (optionally including authentication), UP function selection and control, configuration of a traffic steering for routing traffic from the UPF entity 130 to an appropriate destination, termination of an interface for policy control functions, implementation of a control part of a policy and quality of service (QOS), lawful intercept (with respect to an SM event and an interface to an L1 system), termination of an session management (SM) part of a NAS message, downlink data notification, an initiator of access network (AN)-specific SM information (transferring to the RAN 110 via N2 by going through the AMF entity 120), determining a session and service continuity (SSC) mode of a session, a roaming function, and the like. Some or all of the functions of the SMF entity 135 may be supported in a single instance of a single SMF entity.

The unified data management (UDM) entity 145 may store a user's subscription data, policy data, and the like. The UDM entity 145 may include two parts, that is, an application front end (FE) and a user data repository (UDR).

The UPF entity 130 may transfer a downlink PDU received from the DN 175 to the UE 100 via the RAN 110, and may transfer, to the DN 175, an uplink PDU received from the UE 100 via the RAN 110. Specifically, the UPF entity 130 may support functions such as an anchor point for intra/inter radio access technology (RAT) mobility, an external PDU session point of interconnection with a data network, packet routing and forwarding, a user plane part of implementation of policy rules and packet inspection, lawful intercept, reporting the amount of traffic used, an uplink classifier for supporting routing of a traffic flow to a data network, a branching point for supporting a multi-homed PDU session, QoS handling for a user plane (e.g., packet filtering, gating, uplink/downlink rate implementation), verifying uplink traffics (a service data flow (SDF) mapping between a service data flow (SDF) and a QoS flow), transport level packet marking in an uplink and downlink, downlink packet buffering, downlink data notification triggering, and the like. Some or all of the functions of the UPF entity 130 may be supported in a single instance of a single UPF.

The application function (AF) entity 170 may interoperate with a 3GPP core network in order to provide a service (e.g., supporting functions such as accessing an effect of traffic routing on an application and a network capability exposure, and interoperating with a policy framework for policy control, or the like).

The RAN 110 is the generic term of a new radio access network that supports both an evolved E-UTRA (E-UTRA) that is an evolved version of the 4G radio access technology and a new radio access technology (new radio (NR)) (e.g., a gNB).

The gNB supports functions for radio resource management (i.e., radio bearer control, radio admission control, connection mobility control, dynamic allocation of resources (i.e., scheduling) to a UE in an uplink/downlink), internet protocol (IP) header compression, encryption of a user data stream and integrity protection, selecting an AMF in the case of attachment of a UE if routing to the AMF is not determined based on information provided to the UE, user plane data routing to a UPF(s), control plane information routing to an AMF, connection setup and release, scheduling and transmitting a paging message (generated from an AMF), scheduling and transmitting system broadcast information (generated from an AMF or operating and maintenance (O&M)), measuring for mobility and scheduling and configuring a measurement report, transport level packet marking in an uplink, session management, supporting network slicing, QoS flow management and mapping to a data radio bearer, supporting a UE in an inactive mode, distributing a NAS message, a NAS node selecting function, sharing a radio access network, dual connectivity, tight interworking between an NR and a E-UTRA, and the like.

The UE 100 is a user equipment. The user equipment may also be referred to as a terminal, a mobile equipment (ME), a mobile station (MS), or the like. In addition, the user equipment may be a portable device such as a notebook, a portable phone, a personal digital assistant (PDA), a smartphone, a multi-media device, or the like, or may be a non-portable device such as a personal computer (PC), an in-vehicle device, or the like.

In 3GPP systems, conceptual links connecting NFs in the 5G system are defined as reference points. In the following, reference points included in the 5G system architecture described in FIG. 1 are provided below:
N1: a reference point between a UE and an AMF;
N2: a reference point between an (R) AN and an AMF;
N3: a reference point between an (R) AN and a UPF;
N4: a reference point between an SMF and a UPF;
N5: a reference point between a PCF and an AF;
N6: a reference point between a UPF and a DN;
N7: a reference point between an SMF and a PCF;
N8: a reference point between a UDM and an AMF;
N9: a reference point between two core UPFs;
N10: a reference point between a UDM and an SMF;
N11: a reference point between an AMF and an SMF;
N12: a reference point between an AMF and an AUSF;
N13: a reference point between a UDM and an authentication server function (AUSF);
N14: a reference point between two AMFs; and/or
N15: a reference point between a PCF and an AMF for a non-roaming scenario, and a reference point between a PCF and an AMF in a visited network for a roaming scenario.

In the 5G system, network slicing refers to a structure and a technology enabling multiple independent logical networks virtualized in a single physical network. In order to satisfy specialized requirements of services/applications, a network operator configures a virtual end-to-end network referred to as a network slice, so as to provide services. In this case, the network slice is distinguished by an identifier referred to as single-network slice selection assistance information (S-NSSAI). The network transmits a set of allowed slices (e.g., allowed NSSAI(s)) to a UE during a UE registration procedure, and the UE transmits and receives application data via a protocol data unit (PDU) session generated via one piece of S-NSSAI (i.e., network slice) among the set of allowed slices. Hereinafter, in an embodiment of the disclosure, the operations of an NF may be understood as the operations of an orchestration and management (OAM).

According to an embodiment, a network data analytic function (NWDAF) entity in a communication system may include a transceiver and at least one processor.

According to an embodiment, the at least one processor may be configured to receive, from a consumer network function (NF) entity via the transceiver, an analytic information request message that requests analytic information associated with NF instances, to collect, via the transceiver, analytic information associated with the NF instances from an orchestration and management (OAM) entity, a network repository function (NRF) entity, or at least one NF entity, in response to the reception of the analytic information request message, to detect at least one NF instance that operates abnormally from among the NF instances, based on the analytic information associated with the NF instances, collected from the OAM entity, the NRF entity, or the at least one NF entity, and to transmit, to the consumer NF entity via the transceiver, information related to the at least one NF instance that operates abnormally.

According to an embodiment of the disclosure, the at least one processor may be configured to transmit, to the OAM entity via the transceiver, a request message that requests analytic information associated with the NF instances, and to receive, from the OAM via the transceiver, a response message including the analytic information associated with the NF instances in response to the request message.

According to an embodiment of the disclosure, the request message may include at least one from among identifiers (IDs) of the NF instances, information related to a scheme of collecting analytic information associated with the NF instances, or information that requests load information of the NF instances.

According to an embodiment of the disclosure, the response message may include at least one from among information related to NF services provided by the NF instances, the number of calls received per unit time, the number of responses with success per unit time, the number of responses with failure per unit time, information related to consumer NFs that subscribe to the NF services, a response delay time, information related to whether a retransmission message is received and the number of retransmissions, the number of calls sent per unit time and related statistic information, the number of reception with success per unit time, the number of reception with failure per unit time, or information indicating that the NF instances subscribe to NF services provided by other NF entities.

According to an embodiment of the disclosure, the at least one processor may be configured to transmit, to the NRF entity via the transceiver, a request message that requests analytic information associated with the NF instances, and to receive, from the NRF entity via the transceiver, a response message including the analytic information associated with the NF instances in response to the request message.

According to an embodiment of the disclosure, the request message may include at least one from among identifiers (IDs) of the NF instances, information related to a scheme of collecting analytic information associated with the NF instances, or information that requests load information of the NF instances.

According to an embodiment of the disclosure, the response message may include at least one from among information related to NF services provided by the NF instances, information related to NF services consumed by the NF instances, or load information of the NF instances.

According to an embodiment of the disclosure, the at least one processor may be configured to transmit, to the at least one NF entity via the transceiver, a request message that requests analytic information associated with the NF instances, and to receive, from the at least one NF entity via the transceiver, a response message including the analytic information associated with the NF instances in response to the request message.

According to an embodiment of the disclosure, the request message may include at least one from among identifiers (IDs) of the NF instances, information related to a scheme of collecting analytic information associated with the NF instances, or information that requests load information of the NF instances.

According to an embodiment of the disclosure, the response message may include at least one from among information related to NF services provided by the NF instances, information related to NF services consumed by the NF instances, or load information of the NF instances.

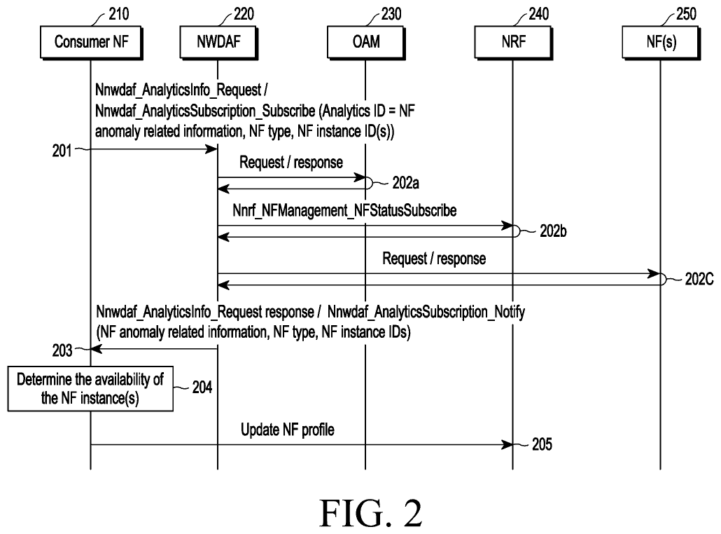

FIG. 2 illustrates a signal flow graph illustrating a procedure that provides analytic information related to abnormal event detection and prediction according to an embodiment of the disclosure.

Referring to FIG. 2, a communication system may include a consumer NF 210, an NWDAF 220, an OAM 230, an NRF 240, and/or an NR(s) 250.

In operation 201, the consumer NF 210 may transmit, to the NWDAF 220, an analytic information request message that requests analytic information associated with NF instances that are targets for abnormal event detection (e.g., signaling storm, NF anomaly, or the like) or an analytic information subscription message that subscribes to analytic information associated with NF instances that are the targets. For example, the analytic information request message may be an Nnwdaf_AnalyticsInfo_Request message. For example, the analytic information subscription message may be an Nnwdaf_AnalyticsSubscription_Subscribe message.

According to an embodiment, the analytic information request message may include the following parameters:
Analytics ID=signaling storm mitigation information (or referred to as “NF load information”);
List of analytics subsets that are requested: information related to NF services being provided, information related to NF services being consumed;
Target of Analytics Reporting: UE ID (e.g., SUPI (subscription permanent identifier));
Analytics Filter: S-NSSAI, NF Instance ID, NF Set ID, NF Type, NF service instance ID, NF service name; and/or
Reporting information: may indicate a periodic notification or an event-based notification. In the case of a periodic notification, cycle information may also be included.

In the case of an event-based notification, the reporting information may include threshold information:
Notification correlation ID, notification target address;
Area of interest: information associated with an area of interest, and information such as a tracking area (TA), geographic location, or the like may be included; and/or
Required accuracy.

Examples of the case in which the consumer NF 210 transmits the analytic information request message are as follows.

(1) The case in which the consumer NF 210 is a network repository function (NRF) and is to perform abnormal event detection or the like based on analytic information associated with NF instances registered with the consumer NF 210.

(2) The case in which an NF instance that the consumer NF 210 selects and uses exists (e.g., the case in which the consumer NF 210 calls an NF service of a predetermined instance, or the like).

(3) The case in which the consumer NF 210 utilizes the analytic information for NF selection.

(4) The case in which the consumer NF 210 needs the analytic information associated with a predetermined NF instance set.

In operation 202, when the analytic information request message of operation 201 is received, the NWDAF 220 may perform an operation of collecting signaling storm mitigation information associated with the NF instance(s) corresponding to the received analytic information request message. The NWDAF 220 may collect signaling storm mitigation information associated with the NF instance(s) from the OAM 230, the NRF 240, or the NF(s) 250, according to an embodiment. Operation 202 may include at least one of operation 202a, operation 202b, and operation 202c. The case of collecting the signaling storm mitigation information associated with the NF instance(s) from the OAM 230 may correspond to operation 202a. The case of collecting the signaling storm mitigation information associated with the NF instance(s) from the NRF 240 may correspond to operation 202b. The case of collecting the signaling storm mitigation information associated with the NF instance(s) from the NF(s) 250 may correspond to operation 202c.

In operation 202a, the NWDAF 220 may transmit a request message including the following information associated with the NF instance(s) or NF service instance(s) to the OAM 230:
NF instance ID(s) or NF service instance ID(s): An NF instance ID(s) of which information needs to be collected may be included;
Reporting information: A periodic information collection scheme or an event-based information collection scheme may be included. In the case of a periodic information collection scheme, a message transmission cycle for collecting information may be included. In the case of an event-based information collection scheme, information indicating an event associated with a target NF instance or NF service instance may be included. For example, an event for a target NF instance or NF service instance may include an event in which the number of retransmissions of the NF instance or NF service instance reaches the maximum number of retransmissions, or an event in which the number of calls to the NF instance or NF service instance per unit time is greater than or equal to a threshold; and/or
NF instance related information request indicator: An indicator for requesting one or more from among pieces of information described in operation 202b as given below may be included.

When the request message that requests the information associated with an NF instance is received from the NWDAF 220, the OAM 230 may transmit, to the NWDAF 220, information associated with an NF instance ID(s) and/or NF service instance ID(s) included in the request message via a response message. The response message may be transmitted periodically or based on a threshold according to the reporting information included in the request message received from the NWDAF 220. Specifically, the response message transmitted from the OAM 230 may include the following information for each NF instance.
Information related to NF services being provided: Information associated with an NF service provided by a target NF instance(s) or NF service instance(s) may be included. The following information may be provided together with an NF instance ID that transmits a request message (e.g., information collection request message), an NF instance ID that receives the request message and/or NF service instance ID. The following information may be provided in association with one or more from among NF service instances provided by an NF instance. Specifically, one or more of the following information may be included in the response message.
The number of calls received per unit time (e.g., number of requests being received per second) and related statistic information (e.g., average value, last value (e.g., number of calls during last 30 seconds), maximum value, minimum value, deviation of last value, standard deviation, or the like), and the number of calls received per unit time may be provided by percentages (e.g., a current value relative to the allowable total number of calls).
The number of responses with success per unit time (e.g., number of responses with success per second).
The number of responses with failure per unit time (e.g., number of responses with failure per second).
Subscribing (or active) Consumer NF information: Information associated with a consumer NF that subscribes to an NF service provided by an NF instance may be included. An NF instance ID(s) and the address of the corresponding NF instance, the total number of NF instances, or the like may be included.
Response delay time (e.g., a time that the OAM 230 spends from reception of an analytic information request message from the consumer NF 210 to transmission of a response message).
Whether a retransmission message is received and/or the number of retransmissions.
Information related to NF services being consumed: Information related to a corresponding request message(s) may be included when a target NF instance(s) transmits a request message associated with an NF service instance(s) (i.e., calls a predetermined NF service) (e.g., when an NF instance ID associated with an AMF is included in the analytic information request message of operation 201 and the AMF has transmitted, to an SMF, a request message for a predetermined NF service, the corresponding information may be included). Specifically, one or more of the following information may be included.
The number of calls sent per unit time and related statistic information (e.g., number of requests being sent per second) (e.g., average value, last value (e.g., number of calls during last 30 seconds), maximum value, minimum value, deviation of a last value, standard deviation, or the like). For example, the number of calls sent per unit time and related statistic information may be provided by percentages (e.g., a current value relative to the allowable total number of calls).
The number of receptions with success per unit time (e.g., number of received responses with success per second).
The number of receptions with failure per unit time (e.g., number of responses with failure received per second).
Subscribing (or active) producer NF information: When an NF instance subscribes to an NF service provided by another producer NF or a corresponding context exists, corresponding information is indicated. An NF instance ID(s), an NF type, an FRQDN, an NF service instance ID(s), an NF service instance name, the total number of NF instances, or the like may be included in the subscribing (or active) producer NF information.
Response delay time (e.g., a time spent from transmission of an NF service request to a producer NF to transmission of a response message).
The number of timeouts/whether a timeout occurs, the number of retransmission message transmissions and/or whether the maximum number of retransmissions is reached, or the like.

In operation 202b, the NWDAF 220 may transmit a message that requests information associated with the NF instance(s) or NF service instance(s) to the NRF 240. The message that the NWDAF 220 transmits to the NRF 240 may include at least one from among the information included in the message that the NWDAF 220 transmits to the OAM 230 in operation 202a, or may additionally include an indicator that requests NF load information. When the NRF 240 receives the corresponding request message from the NWDAF 220, the NRF 240 may transmit, to the NWDAF 220, a message including at least one from among information related to NF services being provided, information related to NF services being consumed, and NF load information in association with the NF instance(s) corresponding to the request message. The NF load information is a value indicating an NF load (e.g., a value indicating an NF load relative to an NF capacity, and, for example, expressed by percentages), and may include an NF capacity. In association with an AMF, the number of registered UEs and the number of PDU sessions may be included. In association with an SMF, the number of PDU sessions may be included. In association with a UPF, the number of PDU sessions, a UL/DL forwarding load (e.g., a percentage value indicating a current usage amount relative to a UL/DL forwarding capacity of the UPF), or the like may be included.

In operation 202c, the NWDAF 220 may transmit a message that requests information associated with the NF instance(s) or NF service instance(s) to the NF(s) 250. The message that the NWDAF 220 transmits to the NFs 250 may include at least one from among the information included in the message that the NWDAF 220 transmits to the OAM 230 in operation 202a, or may additionally include an indicator that requests NF load information. When the NF(s) 250 receives the corresponding request message from the NWDAF 220, the NF(s) 250 may transmit, to the NWDAF 220, a message including at least one from among information related to NF services being provided, information related to NF services being consumed, NF load information in association with the NF instance(s) corresponding to the request message.

In operation 203, based on the information included in the messages received in operations 202a, 202b, and/or 202c, the NWDAF 220 may collect the information associated with the NF instance(s) included in the analytic information request message of operation 201. When an NF instance ID(s) associated with a producer NF is included in the messages received in operations 202a, 202b, and 202c, and when an NF instance ID(s) associated with the consumer NF 210 is included, information collection of operation 202a (or operation 202b or operation 202c) may be additionally performed by including information associated with the corresponding NF instance ID(s) for additional analysis.

Based on the collected information, the NWDAF 220 may detect NF instances that abnormally operates (e.g., NF instances related to a signaling storm), and may transmit a response message or a notification message to the consumer NF 210. Based on a threshold (e.g., the number of calls received per unit time, the number of responses indicating failure, a response time, the number of associated NF instances, or the like) for each parameter stored in configuration information associated with parameters included in the collected information, the NWDAF 220 may determine an abnormal NF instance(s).

The response message or the notification message may include the following information.
NF instance(s) that need to be suspended, time, reason: An NF instance ID(s) that needs to be suspended (due to an abnormal operation), time information for suspension (e.g., a start time and end time, a time needed for holding a suspended status, or the like), or the like may be included. Reason may include a reason for suspension. For example, information indicating that the number of calls per unit time (or transactions per second) is greater than or equal to a threshold call number, information indicating that a response time exceeds a threshold response time, information indicating an unreachable status, information indicating a poor connection condition, or the like may be included. According to an embodiment, the poor connection condition may be identified based on various parameters associated with a channel condition.
NF instance(s) that can be resumed, time: an NF instance ID(s) expected to normally operate, time information (e.g., start time, end time, or the like) associated with a time in which a normal operation is expected.
NF instance ID(s), and current values and/or predicted values of subsequent parameters for each NF instance: information related to NF services being provided, information related to NF services being consumed, NF load, NF capacity.
NF instance ID(s), and threshold values for subsequent parameters for each NF instance: information related to NF services being provided, information related to NF services being consumed, NF load, NF capacity.
Notification correlation ID: An identifier indicating a notification associated with subscription may be included.
Reason may include information indicating a corresponding case.
NF instance ID(s) to be used: An NF instance ID of which the usage by NF consumers needs to be promoted due to an energy use standard may be included. Together with the NF instance ID(s) to be used, a time and a reason may be included.

In operation 204, when the NF instance ID(s), and the information related to NF services being provided, information related to NF services being consumed, NF load, and NF capacity for each NF instance, are received from the NWDAF 220, the consumer NF 210 may determine an unavailable (or available) NF instance(s) based on a threshold (e.g., the number of calls received per unit time, the number of responses indicating failure, a response time, the number of associated NF instances, or the like) for each parameter stored in the configuration information associated with the corresponding parameters. When the NF instance ID(s), and the threshold values for the information related to NF services being provided, information related to NF services being consumed, NF load, and NF capacity for each NF instance are received from the NWDAF 220, the consumer NF 210 may determine an unavailable (or available) NF instance(s) based on the corresponding threshold value.

When the NF instance(s) that need to be suspended is received from the NWDAF 220, the consumer NF 210 may determine an NF instance ID(s) included in the corresponding message as an unavailable NF instance(s).

When the NF instance(s) that can be resumed is received from the NWDAF 220, the consumer NF 210 may determine an NF instance ID(s) included in the corresponding message as an unavailable NF instance(s).

When a predicted value or prediction information (e.g., NF instance ID and time) is received from the NWDAF 220, the consumer NF 210 may determine availability of an NF instance in consideration of the prediction information (e.g., time) (e.g., when the prediction information indicates unavailability of an NF instance during a predetermined time, the consumer NF 210 may determine that the NF instance is unavailable during the predetermined time).

The consumer NF 210 may perform an operation of changing the NF status of an NF profile corresponding to an unavailable NF instance(s) to a deregistered or suspended status. For example, when the consumer NF 210 determines that the consumer NF 210 itself is unavailable based on a message received from the NWDAF 220, the consumer NF 210 may transmit, to the NRF 240, a message including an NF status configured to a deregistered or suspended status and a message including an NF instance ID, so as to update its NF status.

Alternatively, when the consumer NF 210 is an NRF, the NRF may update the NF status of an unavailable NF instance(s) to a deregistered or suspended status. Alternatively, when the consumer NF 210 is an NRF, the NRF may update the NF status of an available NF instance(s) to a registered status.

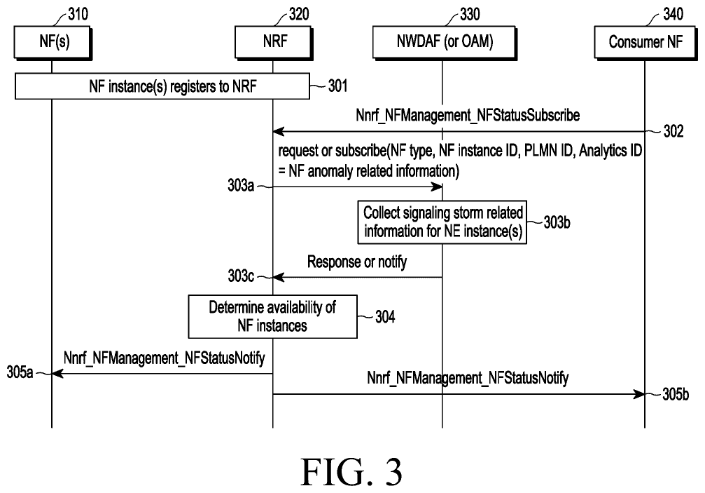

FIG. 3 illustrates a signal flowgraph illustrating an NF status update or NF priority update procedure based on NF analytic information according to an embodiment of the disclosure.

Referring to FIG. 3, a communication system may include NF(s) 310, an NRF 320, an NWDAF (or OAM) 330, and/or a consumer NF 340.

First, an NF instance is associated with a predetermined NF type. At least one NF instance may exist in a predetermined NF type (i.e., NF type or category).

A load (or NF load) of an NF instance may be used as the same meaning as a load percentage (0 to 100) relative to the capacity of the NF instance, or the like.

In operation 301, the NF(s) 250 (or NF instance) (e.g., NF(s) of FIG. 2) may perform an NF registration procedure with the NRF 320 (e.g., NRF 240 of FIG. 2) (i.e., may transmit a registration request message to the NRF 320). When a service communication proxy (SCP) is used, the SCP, instead of the NF(s) 310, may transmit a registration request message to the NRF 320. In the registration request message, an NF profile may be included. In the NF profile, an NF type (information indicating a predetermined NF type, for example, information indicating one of an AMF, an SMF, or an UPF), an NF instance ID (unique identification information capable of identifying an NF instance), a fully qualified domain name (FQDN) or an internet protocol (IP) address of NF (FQDN that is address information of an NF instance or IP address), or the like may be included.

In the registration request message, an NF status update allowance indicator may be included.

In the registration request message, an NF priority update allowance indicator may be included.

The NF status update allowance indicator and/or NF priority update allowance indicator may be included in the NF profile.

The NRF 320 may transmit, to the NFs 310, a response message in response to the registration request.

In operation 302, the consumer NF 340 (e.g., consumer NF 210 of FIG. 2) may transmit, to the NRF 320, a subscription request (e.g., subscription request message) in association with an NF status of an NF instance(s). This is the case of transmitting, to the NRF 320, a subscription request in association with an NF instance that the consumer NF 340 selects and uses (e.g., the consumer NF(s) 310 calls an NF service of the corresponding NF instance, or the like).

The subscription request message may include at least one information from among the following information:
PLMN (public land mobile network) ID: a PLMN identifier. Target information: Information for specifying a target NF instance to subscribe to may be included. For example, at least one from among an NF type, an NF instance ID, an S-NSSAI, and an NSI ID may be included; and/or
Candidate NF profile request indication: When an NF instance corresponding to a target is unavailable (e.g., when the status is changed from a registered status to a deregistered or suspended status), an indicator requesting transmission of a candidate NF profile may be included.

When the subscription request message is received, the NRF 320 may transmit a response message including a callback uniform resource identifier (URI).

In operation 303a, the NRF 320 may transmit a request message for obtaining analytic information (e.g., signaling storm related analytic information) associated with a target (e.g., registered NF instances or NF instances including NF profile change allowance indicators among the registered NF instances) via an NWDAF (or OAM) 330 (e.g., NWDAF 220 or OAM 230 of FIG. 2). In this instance, the procedure and message same as operation 201 of FIG. 2 may be used, and thus, herein, redundant descriptions are omitted.

In operation 303b, the procedure and message same as operation 202 (operation 202a, operation 202b, and operation 202c) of FIG. 2 may be used, and thus, herein, redundant descriptions are omitted.

In operation 303c, the procedure and message same as operation 203 of FIG. 2 may be used, and thus, herein, redundant descriptions are omitted.

In operation 304, the NRF 320 may determine availability for the NF instances. In operation 304, the procedure and message same as operation 204 of FIG. 2 may be used, and thus, herein, redundant descriptions are omitted.

In operation 305a, the NRF 320 may transmit, to the NF(s) 310, a message including information that notifies NF instances of which the NF statuses are changed from a registered status to a suspended or deregistered status (or vice versa) in operation 304.

The corresponding message, when the NRF 320 receives an NF update message, may be transmitted as a response message (Nnrf_NFManagement_NFUpdate response) in response thereto.

Alternatively, the corresponding message may be transmitted as a separate notification message (e.g., Nnrf_NFManagement_NFStatusNotify or Nnrf_NFManagement_NFDeregisterNotification request).

The corresponding message may include at least one of the following parameters:
NF status changed indication (event type when Nnrf_NFManagement_NFStatusNotify is used): An indicator indicating a change of an NF status may be included;
Cause, back-off timer: When an NF status is changed to a deregistered or suspended status, a cause (e.g., deactivation or suspension due to a signaling storm) and a back-off timer may be included; and/or
NF instance ID, NF status (registered, deregistered, or suspended) may be included. Alternatively, an NF profile including an NF instance ID and an NF status may be included.

The NF(s) 310 (or NF instance) may update an NF status based on a message received from the NRF 320. In addition, when a back-off timer is received, it may not transmit an NF update message (e.g., heartbeat message) or NF register message during the corresponding time.

In operation 305b, when an NF status for an NF instance is updated, the NRF 320 may may transmit a message including information that notifies the same to the consumer NF 340 that subscribes to the corresponding NF instance (or that uses the corresponding NF instance).

The corresponding message may be, for example, Nnrf_NFManagement_NFStatusNotify, Nnrf_NFManagement_NFDeregisterNotification request, or another message.

The corresponding message may include at least one of the following parameters.
Event type: When an NF status is updated to a deregistered or suspended status, an updated NF profile or an event type indicating a deregistered NF (or suspended NF) may be included.

When an NF status is updated to a registered status, an updated NF profile or an event type indicating a registered NF may be included:
NF profile: An NF profile including an NF instance ID and an updated NF status (i.e., deregistered/suspended or registered) may be included. When an NF status is changed, time information associated with a time in which the changed NF status is applied may be transmitted together; and/or
Candidate NF profile: When an NF status is updated to a deregistered/suspended status, an NF profile(s) associated with a candidate NF instance(s) capable of being replaced with a corresponding NF instance from among other NF instances in the NF type same as the corresponding NF instance, may be included.

When a candidate NF profile request indication is included in the subscription request message of operation 302, the NRF 320 may include a candidate NF profile(s) in the message.

When the consumer NF 340 receives, from the NRF 320, a message indicating a deregistered status as an NF status, and an NF instance that is changed to a deregistered or suspended status exists among the selected and used NF instances, the consumer NF 340 may determine that an NF instance ID included in the received message is unavailable, and may reselect another NF instance.

When time information is included in the received information, the consumer NF 340 may determine that an NF instance ID included in the received message is unavailable during the corresponding time, and may reselect and use the existing NF instance ID after the corresponding time elapses.

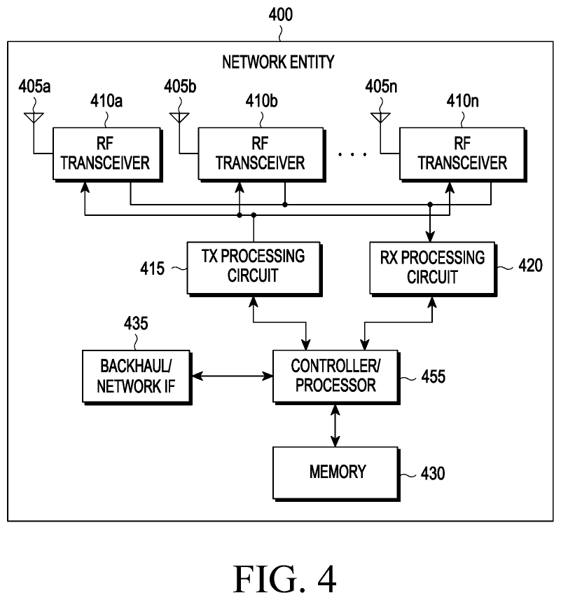

FIG. 4 illustrates an example of the structure of a network entity according to an embodiment of the disclosure.

The embodiment of a network entity illustrated in FIG. 4 is merely an example and thus, FIG. 4 does not limit the scope of the disclosure to a predetermined embodiment of a network entity. According to an embodiment, a network entity may be a network entity that may be included in a communication system, such as a RAN, an AMF entity, a UDM/UDR entity, a PCF entity, or the like.

As illustrated in FIG. 4, the network entity may include a plurality of antennas 405a to 405n, a plurality of RF transceivers 410a to 410n, a transmit (TX) processing circuit 415, and a receive (RX) processing circuit 420. The network entity may include a controller/processor 425, memory 430, and a backhaul or network interface 435.

The RF transceivers 410a to 410n may receive, from the antennas 405a to 405n, input RF signals such as signals transmitted by UEs in a network. The RF transceivers 410a to 410n may down-convert the input RF signals so as to generate IF or baseband signals. The IF or baseband signals may be transmitted to the RX processing circuit 420, and the RX processing circuit 420 may perform filtering, decoding, and/or digitalization on the baseband or IF signals so as to generate processed baseband signals. The RX processing circuit 420 may transmit the processed baseband signals to the controller/processor 425 for additional processing.

The TX processing circuit 415 may receive analog or digital data (sound data, web data, e-mail, interactive video game data, or the like) from the controller/processor 425. The TX processing circuit 415 may encode, multiplex, and/or digitalize the output baseband data so as to generate processed baseband or IF signals. The RF transceiver 410a to 410n may receive the processed baseband or IF signals output from the TX processing circuit 415, and may up-convert the baseband or IF signals to RF signals to be transmitted via the antennas 405a to 405n.

The controller/processor 425 may include one or more processors or other processing devices for controlling the overall operation of the network entity. For example, the controller/processor 425 may control reception of forward channel signals and transmission of reverse channel signals via the RF transceiver 410a to 410n, the RX processing circuit 420, and the TX processing circuit 415 according to the well-known principals. The controller/processor 425 may support additional functions such as more advanced wireless communication functions.

According to various embodiments of the disclosure, the controller/processor 425 may perform the overall operation related to the operations described with reference to FIGS. 2 and 3.

In addition, the controller/processor 425 may support beamforming or directional routing operations differently weighted in order to effectively steer outputted signals in a required direction, the signals being outputted from the plurality of antennas 405a to 405n. Any one of the various functions may be supported by the controller/processor 425 in the network entity.

The controller/processor 425 may execute programs residing in the memory 430, such as an OS, and other processes. The controller/processor 425 may move, to the memory 430 or outside the memory 430, data needed by a process being implemented.

The controller/processor 425 may also be connected to the backhaul or the network interface 435. The backhaul or network interface 435 may allow the network entity to communicate with other devices or systems via a backhaul connection or a network. The interface 435 may support communication via an appropriate wired or wireless connection(s). For example, in case in which the network entity is embodied as a part of a cellular communication system (such as a cellular communication system that supports 5G, LTE, or LTE-A), the interface 435 may allow the network entity to communicate with other network entities via wired or wireless backhaul connections. In the case in which the network entity is embodied as an access point, the interface 435 may allow the network entity to communication via a wired or wireless short-range communication network (local area network) or via a larger network (such as the Internet) using a wired or wireless connection. The interface 435 may include a structure appropriate for supporting communication via a wired or wireless connection such as Ethernet or an RF transceiver.

The memory 430 may be connected to the controller/processor 425. A part of the memory 430 may include RAM, and another part of the memory 430 may include flash memory or other ROM.

Although FIG. 4 illustrates an example of a network entity, various modifications of the example of FIG. 4 may be made. For example, the network entity may include a predetermined number of components illustrated in FIG. 4. As an example, an access point may include a plurality of interfaces 435, and the controller/processor 425 may support routing functions that route data among different network addresses. As another particular example, it is illustrated that a single instance of the TX processing circuit 415 and a single instance of the RX processing circuit 420 are included. However, the network entity may include a plurality of instances for each entity (e.g., one for each RF transceiver). In addition, in FIG. 4, various components may be combined, may be additionally divided again, or may be omitted, or additional components may be added depending on particular needs.

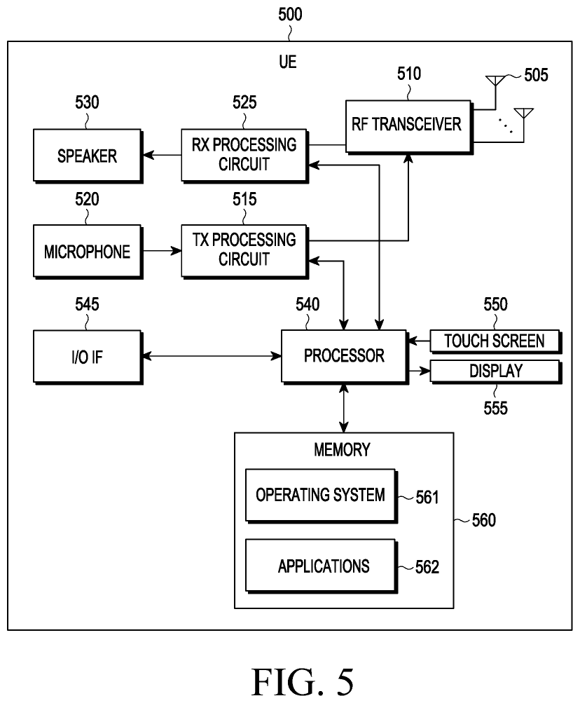

Subsequently, with reference to FIG. 5, the structure of a user equipment (UE) according to an embodiment of the disclosure will be described.

FIG. 5 illustrates an example of the structure of a UE according to embodiments of the disclosure.

The embodiment of a UE illustrated in FIG. 5 is merely an example, and thus FIG. 5 does not limit the scope of the disclosure to a predetermined embodiment of a UE.

As illustrated in FIG. 5, the UE may include an antenna 505, a radio frequency (RF) transceiver 510, a TX processing circuit 515, a microphone 520, and a receive RX processing circuit 525. The UE may include a speaker 530, a processor 540, an input/output (I/O) interface (IF) 545, a touch screen 550, a display 555, and memory 560. The memory 560 may include an operating system (OS) 561 and one or more applications 562.

The RF transceiver 510 may receive, from the antenna 505, an RF signal transmitted and input by a network entity of a network. The RF transceiver 510 may down-convert the input RF signal so as to generate an intermediate frequency (IF) or a baseband signal. The IF or baseband signal may be transmitted to the RX processing circuit 525, and the RX processing circuit 525 may perform filtering, decoding, and/or digitalization on the baseband or IF signal so as to generate processed baseband signals. The RX processing circuit 525 may transmit the processed baseband signal to the speaker 530 (for sound data) or to the processor 540 (for web browsing data), in order to perform additional processing.

The TX processing circuit 515 may receive analog or digital sound data from the microphone 520, or may receive another output baseband data (e.g., web data, e-mail, or interactive video game data) from the processor 540. The TX processing circuit 515 may encode, multiplex, and/or digitalize the output baseband data so as to generate processed baseband or IF signals. The RF transceiver 510 may receive the processed baseband or IF signal output from the TX processing circuit 515, and may up-convert the baseband or IF signal into an RF signal to be transmitted via the antenna 505.

The processor 540 may include one or more processors or other processing devices, and may implement the OS 561 stored in the memory 560 in order to control the overall operation of the UE. For example, the processor 540 may control reception of downlink channel signals and transmission of uplink channel signals via the RF transceiver 510, the RX processing circuit 525, and the TX processing circuit 515 according to the well-known principals. In some embodiments, the processor 540 may include at least one microprocessor or microcontroller.

According to an embodiment of the disclosure, the processor 540 may perform the overall operation related to the operations described with reference to FIGS. 2 and 3.

In addition, the processor 540 may implement other processes and programs contained in the memory 560. The processor 540 may move data to the memory 560 or may move data from the memory 560 when requested by a process being implemented. According to an embodiment, based on the OS program 561 or in response to signals received from network entities or operators, the processor 540 may be configured to implement the applications 562. In addition, the processor 540 may be connected to the I/O interface 545, and the I/O interface 545 may provide, to the UE, a capability of connecting to other devices such as laptop computers and handheld computers. The I/O interface 545 may be a communication path between these accessories and the processor 540.

In addition, the processor 540 may be connected to the touch screen 550 and the display unit 555. An operator of the UE may input data to the UE by using the touch screen 550. The display 555 may be a liquid crystal display, a light emitting diode display, or other displays, which is capable of rendering text and/or at least restricted graphics from web sites or the like.

The memory 560 may be connected to the processor 540. A part of the memory 560 may include random access memory (RAM), and the remaining part of the memory 560 may include flash memory or other read-only memory (ROM).

Although FIG. 5 illustrates an example of a UE, various modifications of the example of FIG. 5 may be made. For example, various components of FIG. 5 may be combined, may be further divided, or may be omitted, or other components may be added in response to a particular need. In addition, as a particular example, the processor 540 may be divided into a plurality of processors, such as one or more central processing units (CPUs) and one or more graphics processing units (GPUs). In addition, although the UE is configured as a mobile phone or a smartphone in FIG. 5, the UE may be configured to operate as different types of mobile or stationary devices.

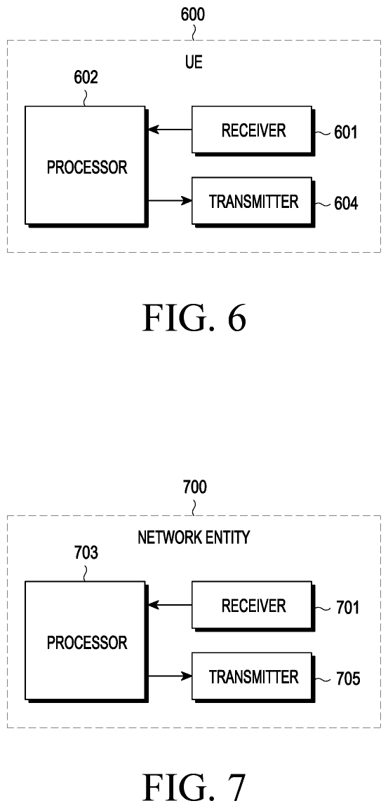

Here, with reference to FIG. 6, another example of the structure of a UE according to an embodiment of the disclosure will be described.

FIG. 6 illustrates a structure of a UE according to an embodiment of the disclosure.

As illustrated in FIG. 6, the UE may include a receiver 600, a transmitter 604, and a processor (or at least one processor) 602. The receiver 600 and the transmitter 604 as a whole may be referred to as a transceiver. The transceiver may transmit/receive signals with other network entities. The signals may include control information and data. To this end, the transceiver may include an RF transmitter configured to up-convert and amplify the frequency of transmitted signals, and an RF receiver configured to low-noise-amplify received signals and down-convert the frequency thereof. In addition, the transceiver may receive signals through a radio channel, output the same to the processor 602, and transmit signals output from the processor 602 through the radio channel. The processor 602 may control a series of processes such that the UE can operate according to the above-described embodiments of the disclosure.

Next, another example of a network entity according to embodiments of the disclosure will be described with reference to FIG. 7.

FIG. 7 illustrates another example of a structure of a network entity according to an embodiment of the disclosure. The network entity (or network device (e.g., RAN node, AF entity, UDM entity, PCF entity, NRF entity, NEF entity, NSSF entity, AUSF entity, AMF entity, SMF entity, UPF entity, AP entity, AS, or base station)) may be one of various entities included in a communication system (e.g., mobile communication network).

As illustrated in FIG. 7, the network entity may include a receiver 701, a transmitter 705, and a processor (or at least one processor) 703. The receiver 701 and the transmitter 705 as a whole may be referred to as a transceiver. The transceiver may transmit/receive signals with the UE. The signals may include control information and data. To this end, the transceiver may include an RF transmitter configured to up-convert and amplify the frequency of transmitted signals, and an RF receiver configured to low-noise-amplify received signals and down-convert the frequency thereof. In addition, the transceiver may receive signals through a radio channel, output the same to the processor 703, and transmit signals output from the processor 703 through the radio channel. The processor 703 may control a series of procedures so that the network entity can operate according to the aforementioned embodiments of the disclosure.

According to an embodiment, a method performed by a network data analytic function (NWDAF) entity in a communication system, may include an operation receiving, from a consumer network function (NF) entity, an analytic information request message that requests analytic information associated with NF instances, an operation of collecting analytic information associated with the NF instances from an orchestration and management (OAM) entity, a network repository function (NRF) entity, or at least one NF entity, in response to the reception of the analytic information request message, an operation of detecting at least one NF instance that operates abnormally from among the NF instance, based on the analytic information associated with the NF instances, collected from the OAM entity, NRF entity, or at least one NF entity, and an operation of transmitting, to the consumer NF entity, information related to the at least one NF instance that operates abnormally.

According to an embodiment of the disclosure, the operation of collecting the analytic information associated with the NF instances from the OAM entity, the NRF entity, or the at least one NF entity in response to the reception of the analytic information request message, may include an operation of transmitting, to the OAM entity, a request message that requests analytic information associated with the NF instances, and an operation of receiving, from the OAM entity, a response message including the analytic information associated with the NF instances in response to the request message.

According to an embodiment of the disclosure, the request message may include at least one from among identifiers (IDs) of the NF instances, information related to a scheme of collecting the analytic information associated with the NF instances, or information that requests load information of the NF instances.

According to an embodiment of the disclosure, the response message may include at least one from among information related to NF services provided by the NF instances, the number of calls received per unit time, the number of responses with success per unit time, the number of responses with failure per unit time, information related to consumer NFs that subscribe to the NF services, a response delay time, information related to whether a retransmission message is received and the number of retransmissions, the number of calls sent per unit time and related statistic information, the number of receptions with success per unit time, the number of receptions with failure per unit time, or information indicating that the NF instances subscribe to NF services provided by other NF entities.

According to an embodiment of the disclosure, the operation of collecting the analytic information associated with the NF instances from the OAM entity, NRF entity, or at least one NF entity, in response to the reception of the analytic information request message, may include an operation of transmitting, to the NRF entity, a request message for requesting analytic information associated with the NF instances, and an operation of receiving, from the NRF entity, a response message including the analytic information associated with the NF instances in response to the request message.

According to an embodiment of the disclosure, the request message may include at least one from among identifiers (IDs) of the NF instances, information related to a scheme of collecting analytic information associated with the NF instances, or information that requests load information of the NF instances.

According to an embodiment of the disclosure, the response message may include at least one from among information related to NF services provided by the NF instances, information related to NF services consumed by the NF instances, or load information of the NF instances.

According to an embodiment of the disclosure, the operation of collecting the analytic information associated with the NF instances from the OAM entity, the NRF entity, or the at least one NF entity in response to the reception of the analytic information request message, may include an operation of transmitting, to the at least one NF entity, a request message that requests analytic information associated with the NF instances, and an operation of receiving, from the at least one NF entity, a response message including the analytic information associated with the NF instances in response to the request message.

According to an embodiment of the disclosure, the request message may include at least one from among identifiers (IDs) of the NF instances, information related to a scheme of collecting analytic information associated with the NF instances, or information that requests load information of the NF instances.

According to an embodiment of the disclosure, the response message may include at least one from among information related to NF services provided by the NF instances, information related to NF services consumed by the NF instances, or load information of the NF instances.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a network data analytic function (NWDAF) entity in a communication system, the method comprising:
receiving, from a consumer network function (NF) entity, an analytic information request message or subscription message including threshold information;
in response to the reception of the analytic information request message or the subscription message, collecting first analytic information from an orchestration and management (OAM) entity, a network repository function (NRF) entity, or at least one NF entity;
deriving second analytic information based on the first analytic information; and
transmitting, to the consumer NF entity, the second analytic information related to the at least one NF that operates abnormally.

2. The method of claim 1, wherein the collecting the first analytic information from the OAM entity, the NRF entity, or the at least one NF entity, comprises:
transmitting, to the OAM entity, a request message that requests the first analytic information associated with the NF instances; and
receiving, from the OAM entity, a response message including the first analytic information associated with the NF instances in response to the request message.

3. The method of claim 2, wherein the request message comprises at least one of identifier (ID) of the NF instances.

4. The method of claim 2, wherein the response message comprises at least one of information related to NF services provided by the NF instances, a number of calls received per unit time, a number of responses with success per unit time, a number of responses with failure per unit time.

5. The method of claim 1, wherein the collecting the first analytic information from the OAM entity, NRF entity, or at least one NF entity, comprises:
transmitting, to the NRF entity, a request message that requests the first analytic information associated with the NF instances; and
receiving, from the NRF entity, a response message including the first analytic information associated with the NF instances in response to the request message.

6. The method of claim 5, wherein the request message comprises at least one of identifiers (IDs) of the NF instances, information related to a scheme of collecting analytic information associated with the NF instances, or information that requests load information of the NF instances.

7. The method of claim 5, wherein the response message comprises at least one of information related to NF services provided by the NF instances, information related to NF services consumed by the NF instances, or load information of the NF instances.

8. The method of claim 1, wherein the collecting the first analytic information from the OAM entity, the NRF entity, or the at least one NF entity, comprises:
transmitting, to the at least one NF entity, a request message that requests the first analytic information associated with the NF instances; and
receiving, from the at least one NF entity, a response message including the first analytic information associated with the NF instances in response to the request message.

9. The method of claim 8, wherein the request message comprises at least one of identifiers (IDs) of the NF instances, information related to a scheme of collecting analytic information associated with the NF instances, or information that requests load information of the NF instances.

10. The method of claim 8, wherein the response message comprises at least one of information related to NF services provided by the NF instances, information related to NF services consumed by the NF instances, or load information of the NF instances.

11. The method of claim 1, wherein the analytic information request message includes at least one of an analytics ID, target of analytics reporting, analytics filter, threshold, area of interest, or required accuracy.

12. A network data analytic function (NWDAF) entity in a communication system, the NWDAF entity comprising:
a transceiver; and
at least one processor,
wherein the at least one processor is configured to:
receive, from a consumer network function (NF) entity via the transceiver, an analytic information request message or subscription message including threshold information;
collect, via the transceiver, first analytic information from an orchestration and management (OAM) entity, a network repository function (NRF) entity, or at least one NF entity, in response to the reception of the analytic information request message or the subscription message;
derive second analytic information based on the first analytic information; and
transmit, to the consumer NF entity via the transceiver, the second analytic information related to the at least one NF that operates abnormally.

13. The NWDAF entity of claim 12, wherein the at least one processor is configured to:
transmit, to the OAM entity via the transceiver, a request message that requests the first analytic information associated with the NF instances; and
receive, from the OAM via the transceiver, a response message including the first analytic information associated with the NF instances in response to the request message.

14. The NWDAF entity of claim 13, wherein the request message comprises at least one of identifier (ID) of the NF instances.

15. The NWDAF entity of claim 13, wherein the response message comprises at least one of information related to NF services provided by the NF instances, a number of calls received per unit time, a number of responses with success per unit time, a number of responses with failure per unit time.

16. The NWDAF entity of claim 12, wherein the at least one processor is configured to:
transmit, to the NRF entity via the transceiver, a request message that requests analytic information associated with the NF instances; and
receive, from the NRF entity via the transceiver, a response message including the first analytic information associated with the NF instances in response to the request message.

17. The NWDAF entity of claim 16, wherein the request message comprises at least one of identifiers (IDs) of the NF instances, information related to a scheme of collecting analytic information associated with the NF instances, or information that requests load information of the NF instances.

18. The NWDAF entity of claim 17, wherein the response message comprises at least one of information related to NF services provided by the NF instances, information related to NF services consumed by the NF instances, or load information of the NF instances.

19. The NWDAF entity of claim 12, wherein the at least one processor is configured to:
transmit, to the at least one NF entity via the transceiver, a request message that requests the first analytic information associated with the NF instances; and
receive, from the at least one NF entity via the transceiver, a response message including the first analytic information associated with the NF instances in response to the request message.

20. The NWDAF entity of claim 19, wherein the request message comprises at least one of identifiers (IDs) of the NF instances, information related to a scheme of collecting analytic information associated with the NF instances, or information that requests load information of the NF instances.
